(19) United States
(12) Patent Application Publication
(10) Pub. No.: US 2011/0277698 A1
(43) Pub. Date: Nov. 17, 2011

(54) Lock and play chew dog toy

(76) Inventor: Nathan S. Chefetz, McLean, VA (US)

(21) Appl. No.: 12/800,542

(22) Filed: May 17, 2010

(51) Int. Cl. A01K 29/00

(52) U.S. Cl. 119/709

(57) ABSTRACT

A pet chew toy, especially for dogs, does not wear out easily, does not get chewed up easily, and which continues to maintain the interest of the pet throughout the life of the chew toy, has a resilient body in the shape of a lock which has a body and a U-shaped member connected to the body. The body is hollow, and has an open bottom wall leading to an interior chamber with a plurality of resiliently deformable ribs extending from the walls of the hollow body and into the interior chamber. One pair of opposed ribs is larger than the others, so as to divide the interior chamber into two smaller compartments. In this way, the hollow body can hold either one large dog treat or two smaller dog treats, such that the deformable ribs grip and retain the dog treat(s) inside the interior chamber. An air hole is preferably also provided in a wall opposite to the open bottom wall, to prevent suction from developing when the pet places its tongue into the interior chamber.

### FIELD OF THE INVENTION

The present invention relates to pet chew toys, useful for training and amusing pets, and to promote healthy pet teeth and gums.

### BACKGROUND OF THE INVENTION

Pet chew toys are well known. Many wear out easily, are chewed up easily, or are not very entertaining to the pet such that the pet loses interest.

There is a great demand for pet chew toys, especially for dog chew toys, which do not wear out easily, do not get chewed up easily, and which continue to maintain the interest of the pet throughout the life of the chew toy.

With ordinary chew toys having a compartment for food, the food is removed too easily. Dogs then consume too much food, too quickly. This can lead to obesity of the dog, which is unhealthy.

Accordingly, it is a problem in the art to provide pet chew toys, especially for dogs, which do not wear out easily, do not get chewed up easily, and which continue to maintain the interest of the pet throughout the life of the chew toy.

Further, there is a need for a longer lasting dog chew toy shape that has a cavity where food is held for longer periods of time, and a toy that promotes human interaction which increases the bond between the dog and a person.

### SUMMARY OF THE INVENTION

From the foregoing, it is seen that it is a problem in the art to provide a device meeting the above requirements. According to the present invention, a device and process are provided which meets the aforementioned requirements and needs in the prior art.

Specifically, the device according to the present invention is a pet chew toy, especially for dogs, which does not wear out easily, does not get chewed up easily, and which continues to maintain the interest of the pet throughout the life of the chew toy.

More particularly, the invention relates to a pet chew toy having a resilient body in the shape of a lock which has a body and a U-shaped member connected to the body. The body is hollow, and has an open bottom wall leading to an interior chamber with a plurality of resiliently deformable ribs extending from the walls of the hollow body and into the interior chamber. One pair of opposed ribs is larger than the others, so as to divide the interior chamber into two smaller compartments. In this way, the hollow body can hold either one large dog treat or two smaller dog treats, such that the deformable ribs grip and retain the dog treat(s) inside the interior chamber. An air hole is preferably also provided in a wall opposite to the open bottom wall, to prevent suction from developing when the pet places its tongue into the interior chamber.

Other objects and advantages of the present invention will be more readily apparent from the following detailed description when read in conjunction with the accompanying drawings.

### BRIEF DESCRIPTION OF THE DRAWINGS

FIG. 1 is a perspective view of the pet toy according to the invention.

FIG. 2 is a bottom elevational view of the pet toy of FIG. 1.

FIG. 3 is a front elevational view of the pet toy of FIG. 1.

FIG. 4 is a rear elevational view of the pet toy of FIG. 1.

FIG. 5 is cross sectional view taken along line 5-5 of FIG. 4.

FIG. 6 is side elevational view of the left side of the pet toy of FIG. 1.

FIG. 7 is a top elevational view of the pet toy of FIG. 1.

FIG. 8 is a schematic view of the interior portion of the pet toy of FIGS. 1-7 used for holding two pet treats.

### DETAILED DESCRIPTION OF THE INVENTION

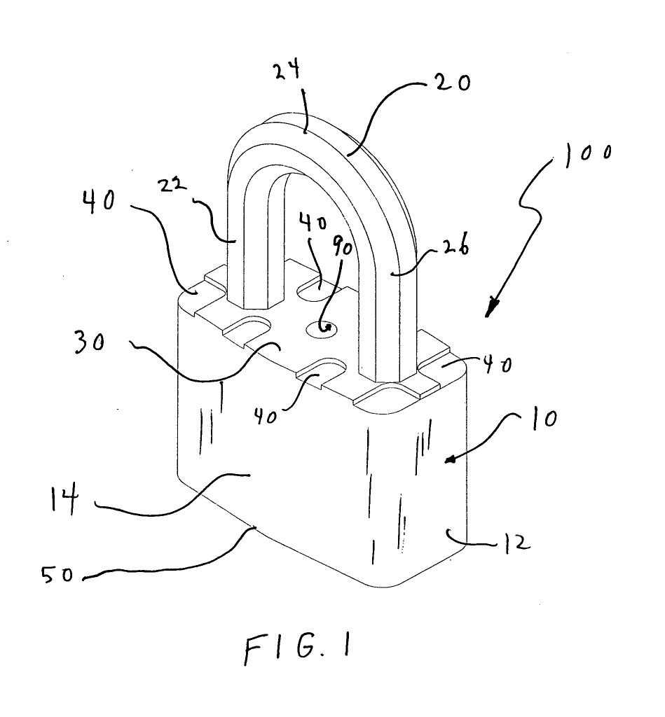

FIG. 1 shows a pet toy 100 having a body 10 and U-shaped portion 20 which are preferably formed integrally, as by molding. The pet toy 100 is preferably formed of a resilient material such as rubber or resiliently deformable plastic material. The pet toy 100 simulates the appearance of a lock including details such as depressions 40 formed in a top wall 30 of the body 10.

The pet toy 100 has a front wall 14 and a right side wall 12. The body 10 of the pet toy 100 has a bottom wall 50. The U-shaped portion 20 has a curved upper portion 24 connected to two straight portions 22 and 26 which join the body 10 at the top wall 30. An air hole 90 is shown, which connects with the interior region 70 to prevent suction when the pet's tongue is inserted into the interior region 70. This enables the pet to easily remove its tongue from the interior region 70.

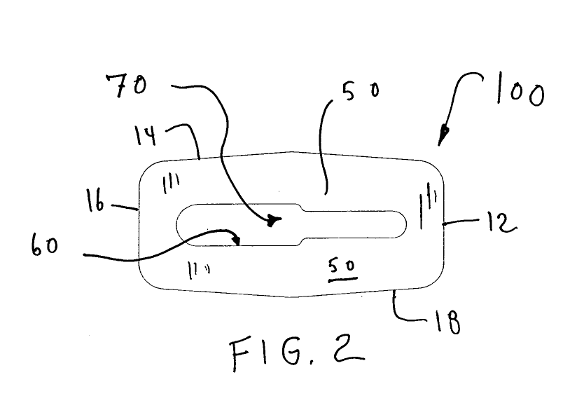

FIG. 2 is a bottom elevational view of the pet toy 100 of FIG. 1, showing an elongated opening 60 which leads into an interior region 70 of the body 10. In FIG. 2, the bottom wall 50 is shown and a rear wall 18 is indicated. The pet toy 100 is sufficiently resilient that, when side walls 12 and 16 are squeezed together, they cause the central portions of the front and rear walls 14 and 18 to move apart, thereby expanding the opening 60 so that a pet treat can be placed inside the an interior region 70.

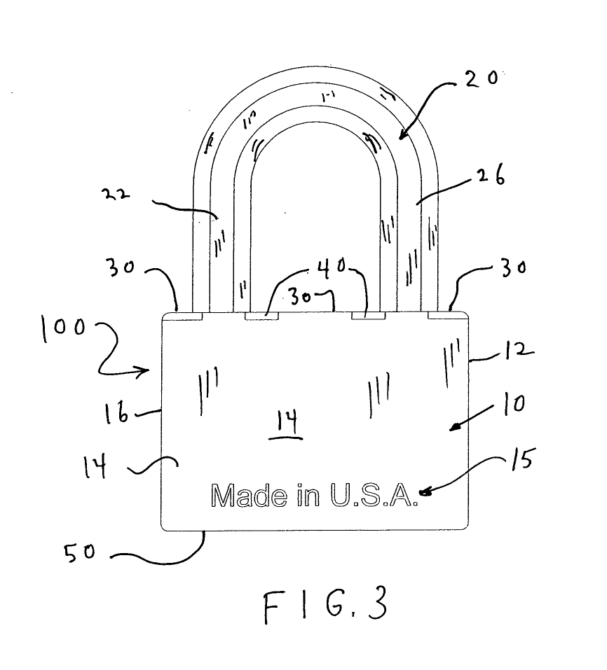

FIG. 3 is a front elevational view of the pet toy 100 of FIG. 1 showing the front wall 14, which bears indicia; however, the indicia can be omitted. The elements shown in this view are as described hereinabove with reference to FIG. 1.

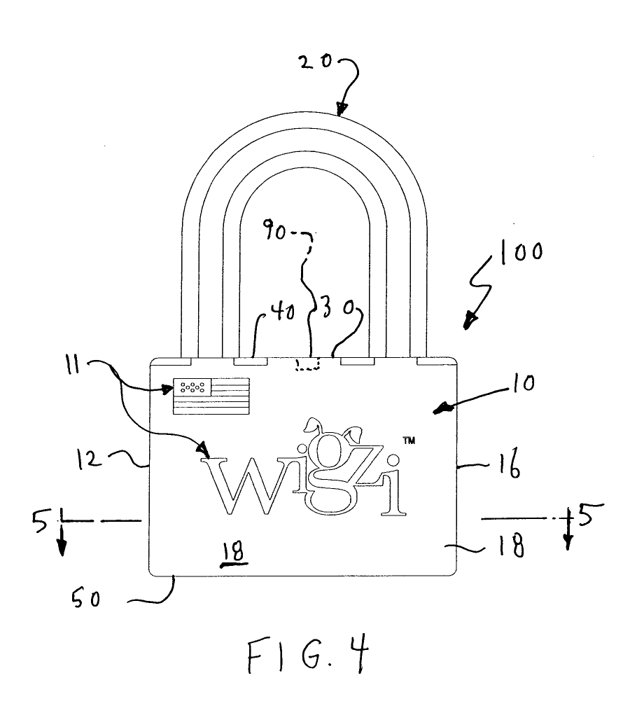

FIG. 4 is a rear elevational view of the pet toy 100 of FIG. 1. Here, the rear wall 18 is shown, bearing indicia 11; however, the indica 11 can be omitted. The rear wall 18 is substantially the same as the front wall 14.

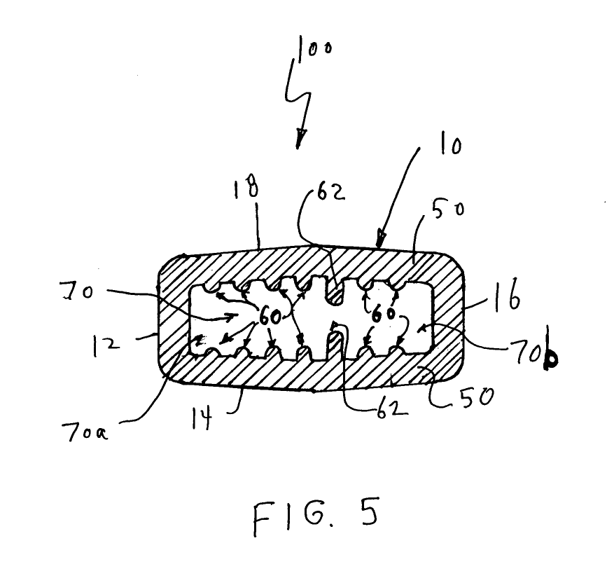

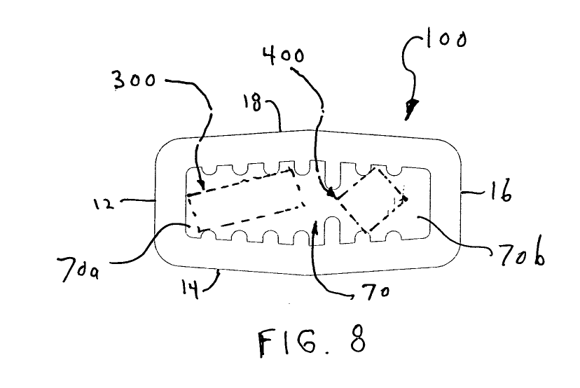

FIG. 5 is cross sectional view of the pet toy 100, taken along line 5-5 of FIG. 4. In this view, the body 10 has the hollow interior region 70. The interior region 70 has a sub-region 70a and a sub-region 70b. A plurality of ribs 60 are disposed on the interior surface of the walls 14 and 18, along with a pair of relatively longer ribs 62, 62 which sub-divides the sub-region 70a and the sub-region 70b. When the interior region 70 of the pet toy 100 is opened by the squeezing together of the side walls 12 and 16, the ribs 60 and 62 separate. This allows insertion of a pet treat (shown in FIG. 8). Release of the pressure on the sidewalls 12 and 16 allows the ribs 60 and 62 to grip the pet treat securely.

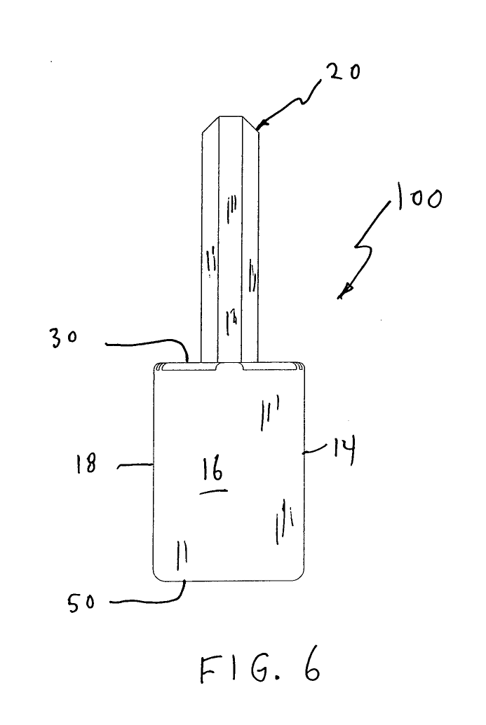

FIG. 6 is a side elevational view of the left side of the pet toy 100 of FIG. 1. It is substantially the same as the right side wall 12 shown in FIG. 1.

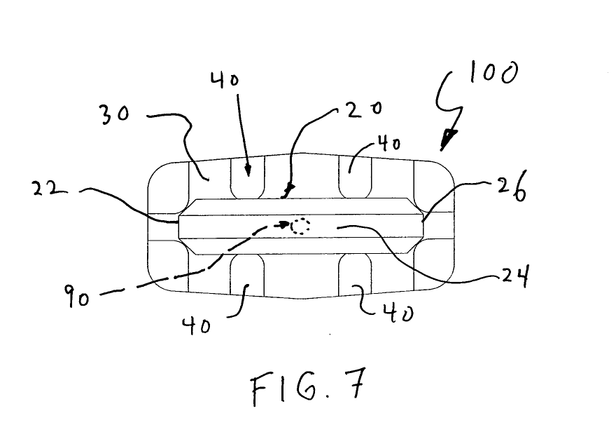

FIG. 7 is a top elevational view of the pet toy 100 of FIG. 1. Here, the top portion of the U-shaped portion 20 appears. The other elements shown are as described in the above with regard to FIG. 1. The air hole 90 is shown in dashed outline. The air hole 90 is provided to prevent suction when the pet's tongue is inserted into the interior region 70, thereby enabling the pet to easily remove its tongue from the interior region 70.

FIG. 8 is a schematic view of the interior portion of the pet toy 100 of FIGS. 1-7 used for holding two pet treats 300 and 400, shown in dashed outline. Alternatively, a single large pet treat could be inserted spanning both regions 70a and 70b, or a single small pet treat can be inserted into the sub-region 70a or the smaller sub-region 70b.

The invention being thus described, it will be evident that the same may be varied in many ways. Such variations are not to be regarded as a departure from the spirit and scope of the invention and all such modifications are intended to be included within the scope of the claims.

What is claimed is:

1. A pet chew toy, especially for dogs, comprising:
a resilient body in the shape of a lock which has a body and a U-shaped member connected to the body; said body having a top wall, front and rear walls, two side walls, and a bottom wall;
said body having a hollow interior, and said bottom wall having an opening therethrough communicating with the hollow interior of the body;
The front and rear walls each having a plurality of first ribs extending therefrom into the hollow interior; said front and rear walls additionally supporting a pair of opposed second ribs which are longer than the first ribs so as to sub-divide the interior region into a first sub-region and a second sub-region;
in a first squeezed condition the side walls are squeezed toward each other such that central portions of the front and rear walls move away from each other, increasing the separation between the first ribs of the front wall from the first ribs of the second wall, and also increasing the separation between the opposed second ribs of the front wall and the rear wall, thereby enabling insertion of a pet treat into the interior region; and
in a second, unsqueezed condition, side walls are resiliently biased toward an unstressed condition away from each other such that central portions of the front and rear walls move toward each other decreasing the separation between the first ribs of the front wall from the first ribs of the second wall, and also decreasing the separation between the opposed second ribs of the front wall and the rear wall, thereby trapping any pet treats inserted into the interior region.
body is hollow, and has an open bottom wall leading to an interior chamber with a plurality of resiliently deformable ribs extending from the walls of the hollow body and into the interior chamber. One pair of opposed ribs is larger than the others, so as to divide the interior chamber into two smaller compartments. In this way, the hollow body can hold either one large dog treat or two smaller dog treats, such that the deformable ribs grip and retain the dog treat(s) inside the interior chamber. An air hole is preferably also provided in a wall opposite to the open bottom wall, to prevent suction from developing when the pet places its tongue into the interior chamber.

2. The pet toy of claim 1, wherein the top wall further comprises an opening therethrough communicating with the interior region of the body 10, so that the opening serves as an air hole, preventing suction from trapping the tongue of a pet in the interior region.
